(19) United States
(12) Patent Application Publication
(10) Pub. No.: US 2014/0109002 A1
(43) Pub. Date: Apr. 17, 2014

(54) COMPUTER DEVICE USER INTERFACE AND METHOD FOR DISPLAYING INFORMATION

(71) Applicant: Square, Inc., San Francisco, CA (US)

(72) Inventors: Spencer W. Kimball, New York, NY (US); James B. McGinnis, New York, NY (US); Peter D. Mattis, Brooklyn, NY (US)

(73) Assignee: Square, Inc., San Francisco, CA (US)

(21) Appl. No.: 14/054,170

(22) Filed: Oct. 15, 2013

Related U.S. Application Data
(60) Provisional application No. 61/714,051, filed on Oct. 15, 2012.

(51) Int. Cl. G06F 3/0484; G06F 3/0485

(52) U.S. Cl. CPC G06F 3/04842; G06F 3/0485
USPC 715/800; 715/810; 715/830; 715/781

(57) ABSTRACT

A computer implemented method is disclosed that includes a computer device with a display. In response to receiving input, the method comprises accessing information from an information library and sorting the information into information groups by grouping the information. Further, the method includes displaying in a first graphical user interface on the display a single subset or multiple subsets of the information groups arranged adjacent to each other within the display, and wherein the information groups each include an access point.

### CROSS-REFERENCE TO RELATED APPLICATIONS

This U.S. non-provisional application claims priority from U.S. provisional application No. 61/714,051, entitled COMPUTER DEVICE USER INTERFACE AND METHOD FOR DISPLAYING INFORMATION, filed Oct. 15, 2012, the disclosure of which is incorporated by reference herein in its entirety to provide continuity of disclosure.

### TECHNICAL FIELD

The present invention relates generally to user interfaces for computer devices and more particularly to a user interface for computer devices that display information.

### BACKGROUND

Computer devices have memory that stores information, including photographs, images, video, music, alphanumeric data, and the like. This information may be stored in local memory or storage on the computer device or stored in memory or storage on a remote computer device or devices, or accessible via a local and/or remote network, for example. Computer devices display this information on displays that typically vary in size depending on the type of computer device. However, computer devices, like any medium, can display only a limited amount of information, i.e., a subset of the total information, and computer devices display information, and often in a way that is not easy to use. A person using the computer device often wastes excessive time searching for information or may overlook information sought.

The aforementioned display of a limited amount of information is not ideal. Accordingly, a new user interface is desired.

### SUMMARY

In one aspect, a computer implemented method is disclosed that includes a computer device with a display. In response to receiving input, the method includes accessing information from an information library and sorting the information into information groups by grouping the information. Further, the method includes displaying in a first graphical user interface on the display a single subset or multiple subsets of the information groups arranged adjacent to each other within the display, and wherein the information groups each include an access point.

In another aspect, a computer implemented method is disclosed that includes a computer device with a display. In response to receiving input, the method includes accessing information from an information library and sorting the information into information groups by grouping the information. Further, the method includes displaying in a first graphical user interface on the display an information banner overlaid on a single subset or multiple subsets of the information groups arranged adjacent to each other within the display, wherein the information groups each include at least one access point that is a gateway into a second graphical user interface, wherein the at least one information banner represents information from the information library, wherein at least a portion of the information banner and at least a portion of underlying information groups move in tandem in the first graphical user interface, and wherein the information banner displays categories of underlying the information groups. Further, the method includes in response to receiving further input, changing a zoom level of said information banner.

In another aspect, a computer device is disclosed that includes a display, one or more processors, memory, and one or more programs, wherein the one or more programs are stored in the memory and configured to be executed by the one or more processors. The programs include instructions for accessing information from an information library and instructions for sorting the information into information groups. Further, the programs include instructions for displaying in a first graphical user interface on the display an information banner overlaid on a single subset or multiple subsets of the information groups arranged adjacent to each other within the display, wherein said information groups each include at least one access point that provides a gateway into a second graphical user interface, wherein the information banner represents information from the information library, wherein at least a portion of the information banner and at least a portion of underlying information groups move in tandem in the first graphical user interface, and wherein the at least one information banner displays categories of underlying the information groups; and instructions for changing a zoom level of the information banner.

### BRIEF DESCRIPTION OF THE DRAWINGS

FIG. 1 is a computer device and operating environment according to one or more aspects described herein.

FIGS. 2A-2G are examples of user interfaces described herein.

FIGS. 3A-3D and 4A-4D are examples of additional user interfaces described herein.

FIGS. 5A-5B are additional examples of user interfaces described herein.

FIGS. 6-7 are flow charts illustrating embodiments of methods described herein.

### DETAILED DESCRIPTION

The following detailed description is merely illustrative in nature and is not intended to limit the embodiments of the invention or the application and uses of such embodiments. Furthermore, there is no intention to be bound by any expressed or implied theory presented in the preceding technical field, background, brief summary or the following detailed description.

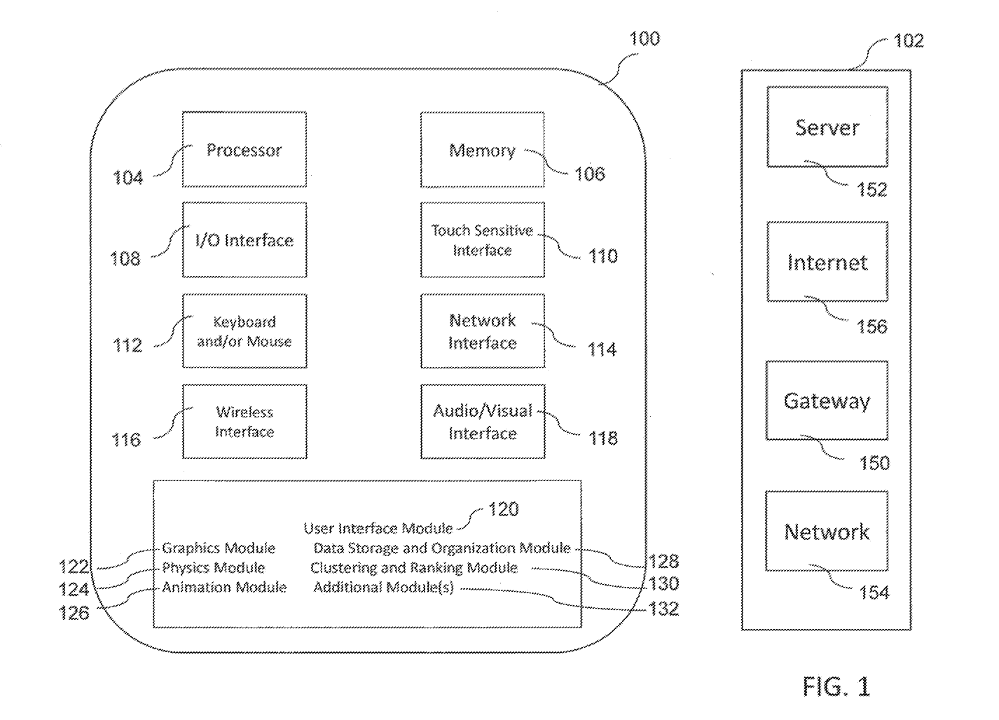

FIG. 1 illustrates an example computer device 100 and operating environment 102 according to at least one aspect described herein. Computer device 100 may be in the form of a desktop computer, a laptop computer, a tablet computer, a server, a cellular device, a mobile phone, a mobile computer, a mobile device, a handheld device, a media player, a personal digital assistant or the like, including a combination of two or more of these items. In the illustrated embodiment, computer device 100 may include one or more software and/or hardware components, including processor 104, memory 106, input-output (I/O) interface 108, touch sensitive interface 110, keyboard and/or mouse 112, network interface 114, wireless interface 116, audio and/or visual interface 118, and user interface module 120. In another embodiment, the computer device includes one or more of these components to form one of the computer devices discussed above. In yet another embodiment, the computer device includes one or more of these components in addition to other components. In another embodiment, the computer device may include more or fewer components than shown or have a different configuration of components. For example, the computer device may have two or more of at least one of the following components: processors, memory, I/O interfaces, and/or user interface modules, set of instructions, and/or the like. Although user interface module 120 is illustrated as a separate component in computer device 100, in another embodiment the user interface module and/or any one of the modules or set of instructions discussed herein may be part of one or more other components, e.g., memory. The components illustrated in FIG. 1 may be implemented in hardware, software or a combination of both hardware and software.

In the illustrated embodiment, operating environment 102 may include gateway 150, server 152, network 154, and/or Internet 156, e.g., global world wide web or internet. Operating environment may include any type and/or number of networks, including wired or wireless internet, cellular network, satellite network, local area network, wide area network, public telephone network, cloud network, and/or the like. In another embodiment, the application discussed herein may operate locally on a computer device, i.e., the application may be wholly functional on its own on a single computer device. In the illustrated embodiment, computer device 100 may communicate with operating environment 102 through server 152 by a wireless network connection and/or a wired network connection. Further, server 152 may connect computer device 100 to the public telephone network to enable telephone functionality (voice, data, and images) of the computer device 100. In another embodiment, operating environment may include gateway, server, network, and/or Internet that are not located together, rather they may be separate, wireless, or may include wired connections.

User interface module 120 controls at least a portion of the user interfaces of computer device 100 that are discussed herein. The user interface module 120 may include at least one of the following: a graphics module 122, a physics module 124, an animation module 126, a data storage and organization module 128, a clustering and ranking module 130, and may include additional module(s) 132. In another embodiment, the user interface module 120 may include a public feed module for social media applications, a conversation feed module, and/or a blog feed module for blogging applications and the like. In another embodiment, the user interface module 120 may include more or fewer modules than shown or have a different configuration of modules. A module may include instructions and/or a set of instructions.

Graphics module 122 may include a number of known software programs for rendering and displaying graphics on the display. In an embodiment, graphics module illustrates at least one arc (or some other 2D or 3D partial or complete shape), at least one gradient, at least one texture, at least one label or information group, and other graphical elements of the applications of the exemplary embodiments discussed herein using the current input, scroll, and/or tracking location(s). The at least one texture may include at least one of the following: text, gradient or opacity shadow, electronic photograph(s), and electronic photograph(s) previewed underneath or presented in an overlay. The graphics module 122 may also provide for transition(s) from summary labels (general) to detailed labels (specific) and the reverse as a user adjusts the zoom of the exemplary embodiments, e.g., increases or decreases the zoom. A user increases the zoom or zooms-in when the user provides input to move to more specific information. A user decreases the zoom or zooms-out when the user provides input to move to more general information.

Graphics may include information and objects that can be shown on a display of the computer device 100. For example, graphics may include icons, text, web sites, animations using each device's application programmer interface(s) as well as open standards such as HTML and OpenGL, icons, videos, electronic images, and all forms of information as defined herein. The graphics module 122 may include an opacity overlay module, visual intensity module, or the like that increases or decreases the opacity or intensity of the graphics and/or information, e.g., when an overlay instruction or module renders a second interface over a first interface, the opacity of the second interface is increased making the first interface more difficult to see, though still visible.

The graphics module 122 may also control operation and presentation of the overlays discussed herein. For example, overlays may slide in or out of view, or fade into or out of existence. Components from one overlay may individually separate and recede along separate paths of animation while components from another overlay individually coalesce or come together by approaching a user interface location from separate paths. The transition from one to many components in parallel or from one to the next component (to the next, serially) proceeds with the objective of introducing and highlighting new content in order to clarify, enhance, or otherwise provide information while maintaining enough content from the previous overlay to maintain a sense of direction and context. For example, an arc or dial having detailed information about locations of events along the periphery of the arc, may be adjusted to include information about the people who were present at those events, therefore, the representations of the people, whether names or photos, would appear and replace the locations by some manner of transition. This is accomplished by presenting on the display a series of successive overlays using an algorithm. For example, the algorithm may control the presentation of information in the user interface by including at least one of the following: locations that are further away from a first location on the user interface may be accentuated as a user navigates toward (zooms-in or moves, closer to) the arc, exceptional photos, like photos that are more clicked upon or photos from people that share less often, may be accentuated, or photos that are bookmarked by a user may be accentuated. Each successive overlay provides either more specific information in one direction, or less specific information in the reverse direction. In another embodiment, the overlay(s) may expand, contract, enlarge, shrink, fade-in, fade-out, slide-in, and/or slide-out in at least one user interface on the display if the computer device 100 and may do so in a vertical and/or horizontal manner or at an angle relative to a horizontal or vertical reference of the display. In another embodiment, when the exemplary arc/dial is modal, a user can do at least one of the following to contract (zoom-in) and/or expand (zoom-out) the dial: pinch the user interface in or out and/or drag an input (finger, stylus, pointer) across the display.

Physics module 124 illustrates at least one graphics element provided by the graphics module 122. Physics module 124 accepts user input and translates the input into at least one computer simulated force and the like, e.g., translation and rotational forces that control the animated speed and direction of the graphical elements. For example, user input can affect arc shape, arc width, quantity of labels displayed and location, position indicators, scroll indicators, portion of arc displayed, rate of arc rotation about a center point, accelerations to slow down, e.g., friction, or speed up, e.g., force applied by a user, the movement of the arc, and the like. Animation module 126 may operate alone or in combination with the physics module 124 to model and animate springs and frictional forces that animate the scroll and tracking locations and/or graphics location and rotation, e.g., location and rotation of the dial, arc, and the like.

Data storage and organization module 128 maintains information metadata, e.g., per-photo and per-conversation metadata. For example, the data storage and organization module 128 may maintain creator or author, date, title, location, recipients, received date, and the like. Further, the data storage and organization module 128 may maintain chronological indexes, full-text inverted indexes, geohash indexes and secondary indexes on relevant extra-dimensional data such as price, distance from home location, name or user identification of participant, and the like.

Clustering and ranking module 130 groups information, e.g., photos, using geo-temporal clustering and ranks the groups using normalized attributes of each group. For example, normalized attributes may include but are not limited to at least one of the following: distance from home location, number of photos or information records, number of participants, number of comments, popularity, and recency of access and other information upon which groups can be compared. In one embodiment, ranking highlights the user's most relevant data (predefined, computed, or user specified) and maintains a level of information density across zoom levels, dropping lower ranked groups as the density of groups increases and adding lower ranked groups as the density of groups decreases. In another embodiment, the clustering and ranking module groups using a predefined or use adjustable time range, e.g., hours, days, weeks, months, years, etc.

A computer device 100 and operating environment 102 illustrate one possible hardware configuration to support the systems and methods described herein, including but not limited to the methods 600 and 700 discussed below. In order to provide additional context for various aspects of the present invention, the following discussion is intended to provide a brief, general description of a suitable computing environment in which the various aspects of the present invention may be implemented. Those skilled in the art will recognize that the invention also may be implemented in combination with other program modules and/or as a combination of hardware and software. Generally, program modules include routines, programs, components, data structures, sets of instructions, etc., that perform particular tasks and functionality or implement particular abstract data types.

Moreover, those skilled in the art will appreciate that the inventive methods may be practiced with other computer system configurations, including single-processor or multiprocessor computer systems, minicomputers, mainframe computers, as well as personal computers, hand-held computing devices, microprocessor-based or programmable consumer electronics, and the like, each of which may be operatively coupled to one or more associated devices. Further, those skilled in the art will realize that these inventive applications, user interfaces, systems, and/or methods may be directly applicable to future displays, input/output and computing technologies, regardless of their transformative qualities. For example, holographic, 3-dimensional display technologies, eye tracking, gesture sensing, even direct thought control are simply technological iterations of the same expressive capacities and apply as clearly to the inventive applications, systems, and/or methods presented herein as a mouse or touchscreen.

The illustrated aspects of the invention may also be practiced in distributed computing environments where certain tasks are performed by remote processing devices that are linked through a communications network. In a distributed computing environment, program modules may be located in both local and remote memory storage devices.

The computer device 100 can utilize an exemplary environment for implementing various aspects of the invention including a computer, wherein the computer includes a processing unit, a system memory and a system bus. The system bus couples system components including, but not limited to, the system memory and the processing unit. The processing unit may be any of the various commercially available processors. Dual microprocessors and other multi-processor architectures may also be employed as the processing unit.

The system bus can be any of several types of bus structure including a memory bus or memory controller, a peripheral bus and a local bus using any of a variety of commercially available bus architectures. The system memory can include read only memory (ROM) and random access memory (RAM) or any memory known by one skilled in the art. A basic input/output system (BIOS), containing the basic routines used to transfer information between elements within the computer device 100, such as during start-up, is stored in the ROM.

The computer device 100 can further include a hard disk drive, a magnetic disk drive, e.g., to read from or write to a removable disk, and an optical disk drive, e.g., for reading a CD-ROM disk or to read from or write to other optical media. The computer device 100 can include at least some form of non-transitory computer readable media. Non-transitory computer readable media can be any available media that can be accessed by the computer device. By way of example, and not limitation, non-transitory computer readable media may comprise computer storage media and communication media. Computer storage media includes volatile and nonvolatile, removable and non-removable media implemented in any method or technology for storage of information such as computer readable instructions, data structures, program modules or other data. Non-transitory computer storage media includes, but is not limited to, RAM, ROM, EEPROM, flash memory or other memory technology, CD-ROM, digital versatile disks (DVD) or other magnetic storage devices, or any other medium which can be used to store the desired information and which can be accessed by the computer device 100.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of non-transitory computer readable media.

A number of program modules may be stored in the drives and RAM, including an operating system, one or more application programs, other program modules, and program data. The operating system in the computer device 100 can be any of a number of commercially available operating systems and/or web client systems, and/or open source operating systems, covering the spectrum of consumer electronics devices: cameras, video recorders, personal media players, televisions, remote controls, etc., as well as all web client systems, including commercial and open source platforms providing thin-client access to the cloud.

In addition, a user may enter commands and information into the computer device 100 through a touch screen 110 and/or keyboard 112 and a pointing device, such as a mouse 112. Other input devices may include a microphone, an IR remote control, a track ball, a pen input device, a joystick, a game pad, a digitizing tablet, a scanner, or the like. These and other input devices are often connected to the processing unit through a serial port interface that is coupled to the system bus, but may be connected by other interfaces, such as a parallel port, a game port, a universal serial bus (“USB”), an IR interface, and/or various wireless technologies. A monitor or other type of display device may also be connected to the system bus via an interface, such as a video adapter. Visual output may also be accomplished through a remote display network protocol such as Remote Desktop Protocol, VNC, X-Window System, etc. In addition to visual output, a computer typically includes other peripheral output devices, such as speakers, printers, etc.

A display can be employed with the computer device 100 to present data that is electronically received from the processing unit. In addition to the descriptions provided elsewhere, for example, the display can be an LPD, LCD, plasma, CRT, etc. monitor that presents data electronically. As discussed herein, the display may include two and three dimensional displays developed in the future that can display the user interfaces. The display may be integrated with computer device 100 and/or may be a stand-alone display. Alternatively or in addition, the display can present received data in a hard copy format such as a printer, facsimile, plotter etc. The display can present data in any color and can receive data from the computer device 100 via any wireless or hard wire protocol and/or standard.

The computer device 100 can operate in a networked environment, e.g., operating environment 102, using logical and/or physical connections to one or more remote computers/devices, such as a remote computer(s). The remote computer(s)/device(s) can be a workstation, a server computer, a router, a personal computer, microprocessor based entertainment appliance, a peer device or other common network node, and typically includes many or all of the elements described relative to the computer. The logical connections depicted include a local area network (LAN) and a wide area network (WAN). Such networking environments are commonplace in offices, enterprise-wide computer networks, intranets and the Internet.

When used in a LAN networking environment, the computer device 100 is connected to the local network 154 through a network interface 114 or adapter. When used in a WAN networking environment, the computer device 100 typically includes a modem, or is connected to a communications server 152 on the LAN, or has other means for establishing communications over the WAN, such as the Internet 156. In a networked environment 154, program modules depicted relative to the computer, or portions thereof, may be stored in the remote memory storage device. It will be appreciated that network connections described herein are exemplary and other means of establishing a communications link between the computers may be used.

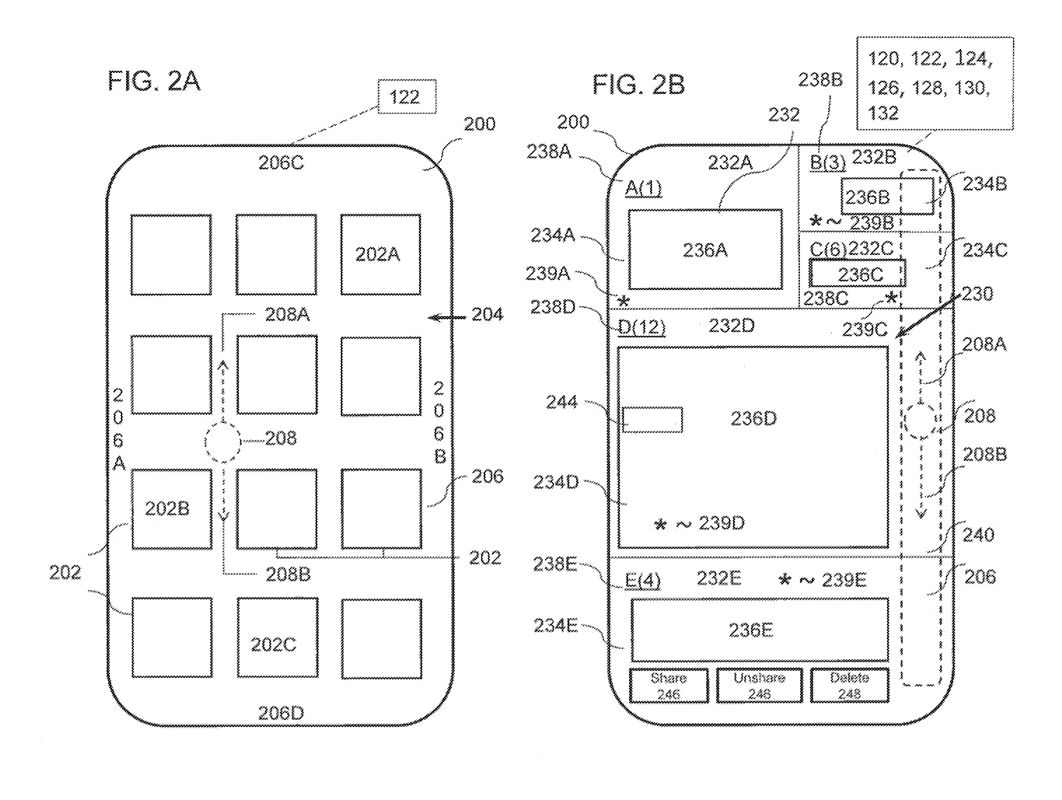

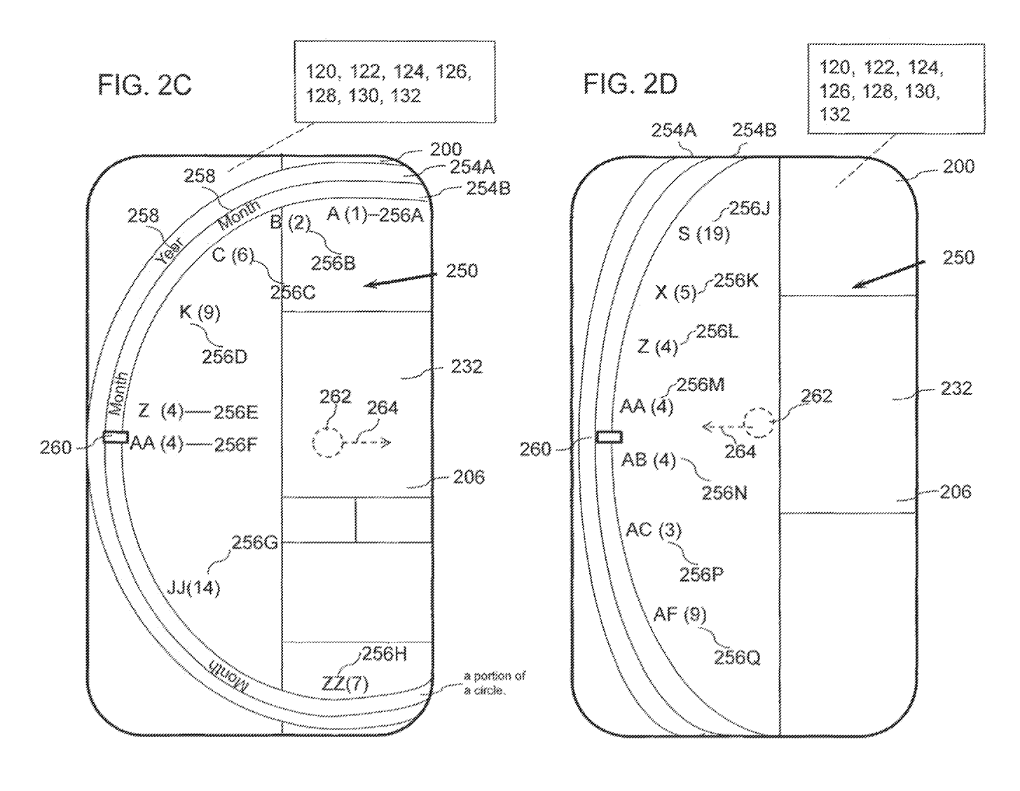

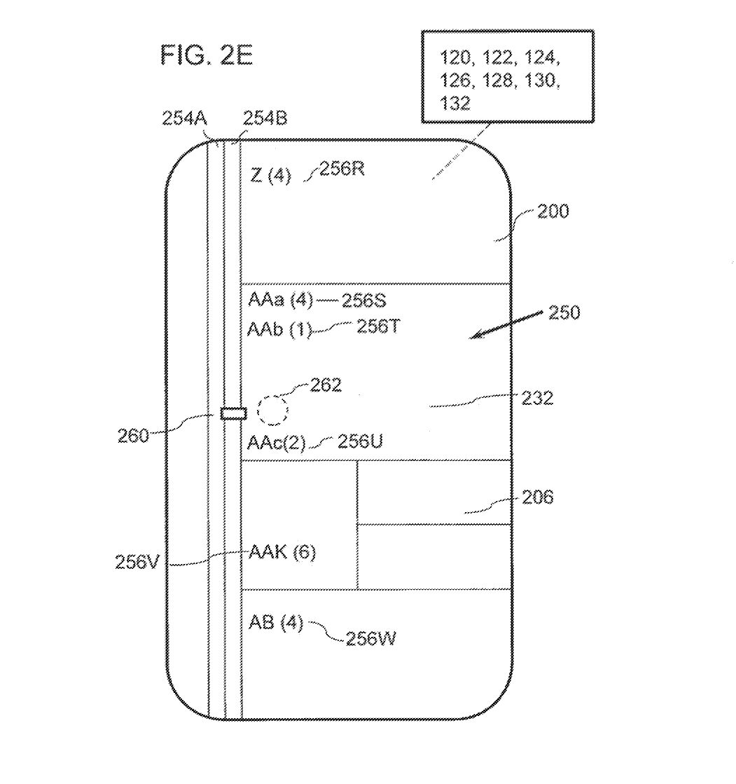

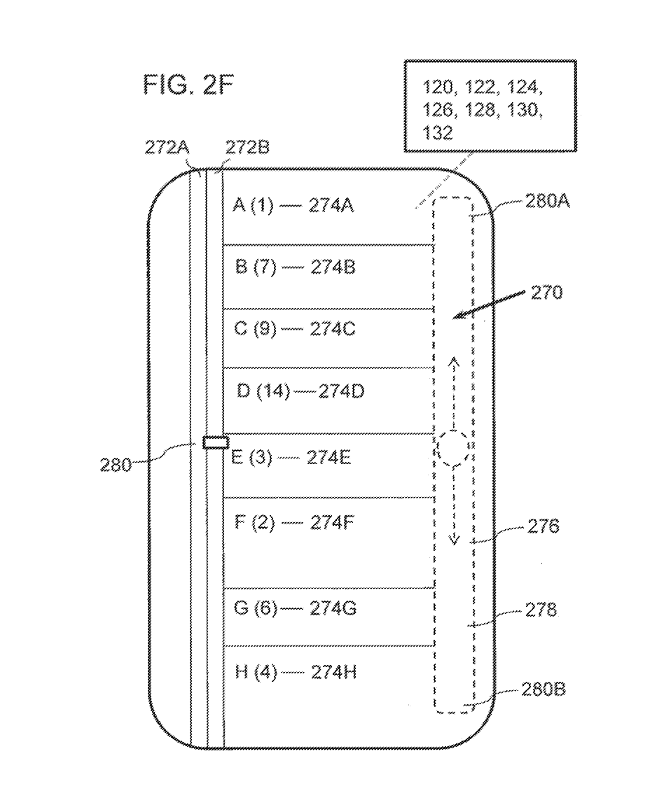

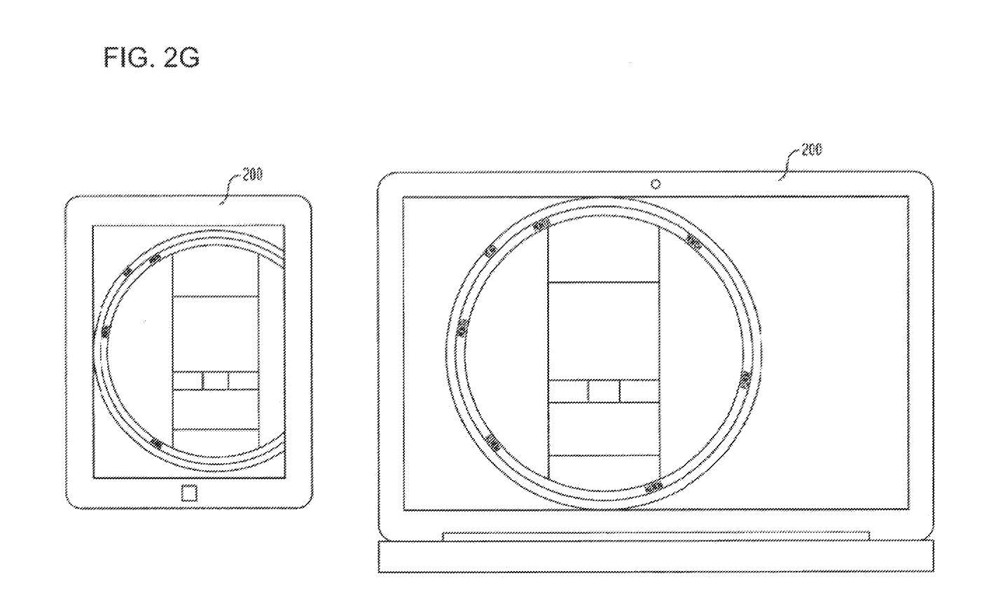

FIG. 2A illustrates an exemplary computer device 200 displaying information 202 in the form of electronic pictures or photographs 202A-C. As used herein, information is defined as including at least one of the following: electronic photographs, digital images, pictures, graphics, videos, videos including forward, rewind and jump scrubbing features, music, books, periodicals, newspapers, alphanumeric text, data, records of any type including business, medical, educational, and governmental records, websites and related graphical, text, and data content, conversations (text and/or audio), user comments and/or strings of user comments, databases, spreadsheets, icons, emoticons, maps and geographical content, and the like. Further, as used herein, information is defined to include interactive content which can be expanded, reduced, searched, modified, browsed, or otherwise affected by the user, e.g., games, photo galleries, stock tickers, weather, maps, news, real estate listings, and the like.

In the illustrated embodiment, graphics module 122 renders and displays information 202 in first graphical user interface 204 on display 206, e.g., a touch-sensitive interface 110 or computer device 200. The square shaped electronic pictures 202A-C (for example) are displayed in chronological order from left 206A to right 206B and from top 206C to bottom 206D of display 206. In other words, electronic pictures having dates earlier in time, based on metadata, user input, or the like, are positioned further towards the bottom 206D of touch-sensitive interface or display 206 relative to other electronic pictures having dates later in time that are positioned further towards the top 206C of display 206. In another embodiment, the information or electronic pictures may be displayed in chronological order in another arrangement, e.g., chronological from bottom to top of a display. More generally, an order along any intuitive dimension is established. For example, for real-estate or other product listings, information or content may be displayed according to price. For news, history, or plot-lines, information or content may be displayed loosely chronological by imputed date of occurrence or report. Further, for a contact list, information or content may be displayed alphabetical, whereas for textbooks or other learning resources, displayed by difficulty or academic rating, and for scientific or medical data, displayed by complexity or level of scale, e.g., from atoms to light years or from cells to muscular, circulatory, or skeletal structures.

In the illustrated embodiment, display 206 has a limited area that displays a relatively small number or subset of electronic pictures 202A-C (information) compared to a total number of pictures, e.g., an information library or the like, that may be stored on a computer device 200. Further, the pictures or information have little or no descriptive information to help a user of the computer device 200 navigate through the total number of pictures or information because of the potentially many heterogeneous peer-level photos or information. For example, photos or information from vastly different geo-temporal locations, or adjacent chapters in a book covering a wide swath of disparate subject matter, may have little or no descriptive information.

In the illustrated embodiment, a user of computer device 200 may move through other information by contacting display 206, e.g., touch-sensitive visual interface, with a finger (represented by dashed circle 208) or the like and moving the finger down 208B to move up or moving the finger up 208A to move down to view photographic information earlier in time or later in time, respectively (or along whichever generalized dimensional axis was selected for the display of the information). In other embodiments, moving down and/or moving up on touch-sensitive visual interface is performed by using at least one hand using one or more fingers or by using any suitable object or the like, such as a stylus, finger, or the like. In another embodiment, a user views earlier or later information by moving left, right, up, and/or down, or some other direction. In yet another embodiment, using eye-tracking software, a user looking past a threshold on the display in the vertical or horizontal direction, or looking at the information of interest would move the focus of information to that point or towards that point on the dimension of primary information content, e.g., time, location, price, complexity, and/or the like. A person skilled in the art will easily recognize that the means of directing focus along this dimension of interest are wide and varied and the inventive application, system, and methods described herein are applicable to all that are now familiar, practical technologies and to most that will become practical technologies over the coming years, including computer-brain interfaces. A more prosaic but eminently desirable interface for a digital camera, video recorder, or personal media display device could feature a manual dial with a touch-sensitive surface to be both flexible like a touch-screen and haptically responsive, e.g., a 3-D mouse. Another embodiment could simply include using tap/click actions to cycle through content in one direction or another. In another embodiment, the computer device 200 may not include a touch-sensitive visual interface or display, but rather includes a keyboard and/or mouse to navigate through a complete set of information.

FIG. 2B illustrates computer device 200 having a second graphical user interface 230, according to an embodiment of the invention. Although first, second, third, and fourth are used to describe graphical user interfaces discussed herein, these descriptions are not intended and should not be construed to be limiting and/or to require or infer a specific order. In the illustrated embodiment, graphics module 122 renders and displays information 232, e.g., electronic pictures, into information groups 232A-E in second graphical user interface 230 on display 206. Clustering and ranking module 130 and/or data storage and organization module 128 use metadata (e.g., dates and location for example) from information 232 to sort the information into one or more information groups 232A-E. At least one of these modules may use data from the information, any element of the metadata, or any metadata element combination for a predefined or user adjustable index or filter. An index takes the information 232, e.g. all the information in the information library or in one or more memory locations, and assigns an index for each piece of information that is used for sorting and/or grouping purposes. For example, the index may sort/group the information by date, date and time, date and time period, date and location, patient identification number, customer identification number, popularity as measured in seconds spent viewing, aggregated across all viewers, number of shares, etc., inverse frequency of search term multiplied by term count, distance between locations (current location or some designated location or location criteria), etc. One skilled in the art would recognize that the index combinations that may be employed by the application, system, and methods disclosed herein are limitless. A filter may be the words typed into a search box, an existing piece of information that is indicated via user input, e.g., long-pressed (e.g., one or more taps and/or holding down on part of a display), pressing or clicking that piece of information's visual representation, in order to highlight it and reinforce its importance. Further, filtering may be done on a fuzzy basis, allowing multiple filtering criteria to apply partially, with information sorted by how closely some linear combination of applicable criteria match, e.g., a piece of information matching substantially all criteria may sort first, whereas a piece of information matching only one criterion may sort last. In the illustrated embodiment, at least one of the modules discussed herein may provide instructions to sort information 232 into data groups, information 232 having a first category (e.g., a first date) into a first information group, e.g., information group 232A, and grouping information having a second category (e.g., a second date) into a second information group, e.g., information group 232B, and the like. In another embodiment, the underlying information is grouped, although the groups may only include one piece or element of information, e.g., each group includes one photograph or includes one piece of data.

In the illustrated embodiment, the second graphical user interface 230 partitions the information groups 232A-E into tiled portions 234A-E on the visible area of second graphical user interface 230, where information groups 232A-E are in reverse chronological order from top to bottom of second graphical user interface 230. For example, information group 232A may include information 232 having metadata dates more recent in time relative to the metadata dates of information 232 in information group 232E Each tiled portion includes at least one representative information sample 236A-E, e.g., at least one electronic picture, electronic information record, or graphic, and further includes a description and subtitle 238A-E, and at least one access point 239A-E. In another embodiment, each tiled portion may include at least one of the following: at least one representative information sample, at least one electronic information record, at least one description and subtitle, and at least one access point. In another embodiment, each tiled portion may be a group or a subset of information. In the illustrated embodiment, the description and subtitle 238A-E may be the preset sorting/grouping index or filter, e.g., date, date and location, common time and location radius, a user-defined index, and/or a user defined description. The description and subtitles 238A-E summarize the contents of the information contained in information groups 232A-E. At least one representative information sample 236A-E may be, for example, the earliest file, record, or the like in the group based on the index, the index score, which may provide a rank based on closeness to filter criteria, be the dates, locations, search terms, or popularity, date, or may be selected based on another predefined or user defined criteria, including explicit designation by the user or others who have previously viewed the same content. In another embodiment, a graphic and/or alphanumeric text may replace or be added to the at least one representative information sample. In another embodiment, the graphical user interface may include another predefined and/or user-defined feature and/or may not include all of the features described above.

In another embodiment, at least one representative sample may include a computer-generated summary of group member content, e.g., a title or cover page that is meant to represent underlying information or content. For textual information, this may include a word cloud composed of the most unusual and oft-repeated words or concepts. For photographs, this might include a collage. For videos, a set of frames. Content for the representative sample may also animate, for example, cycling through the group's constituent pieces of information in round-robin fashion that lasts a set number of seconds for each. In another embodiment, the graphical user interface may be partitioned into other shapes, a plurality of shapes, and/or may be presented in an overlapped arrangement. In another embodiment, the movement of the underlying information includes a parallax effect.

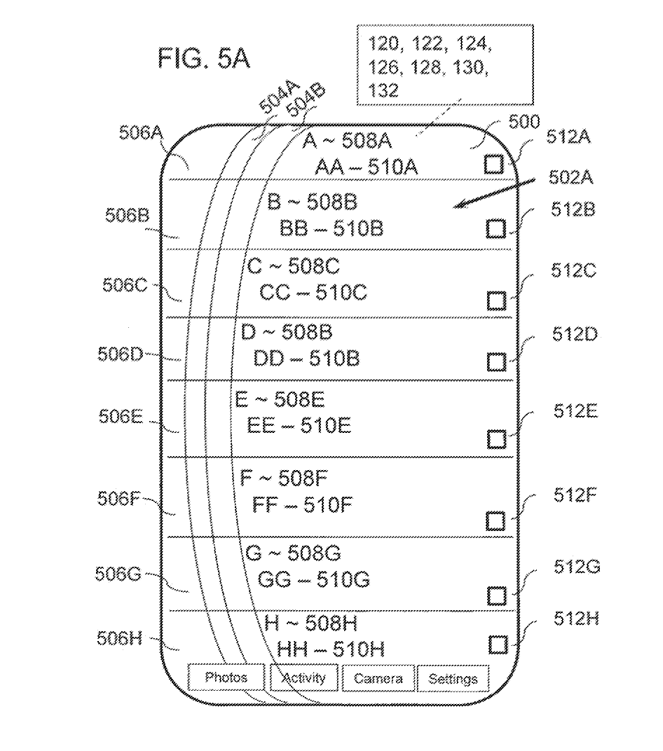

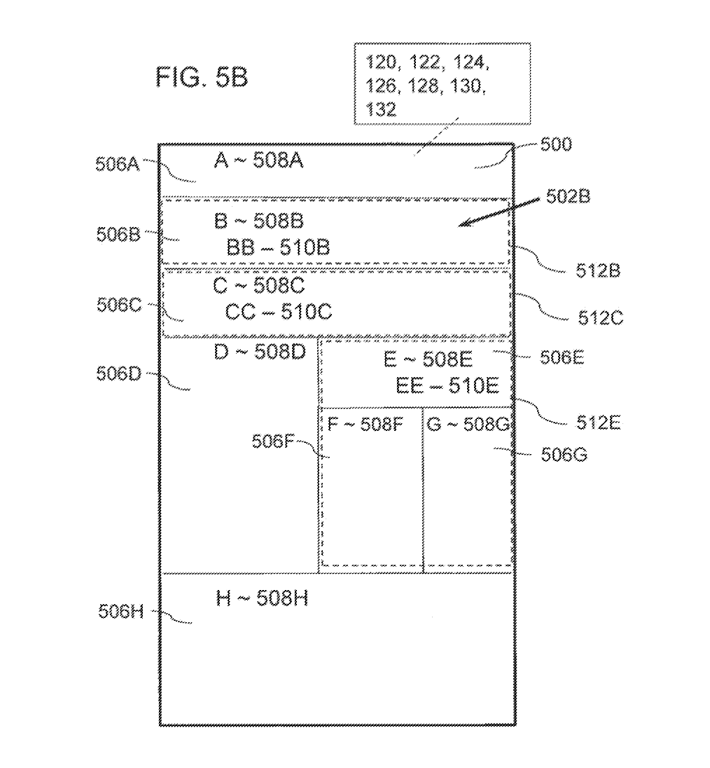

In the illustrated embodiment, at least one access point 239A-E provides a gateway into another user interface that contains additional information and/or content, or some of the same (or similar) content grouped by a different criterion/set of criteria. For example, at least one access point 239A-E may be used to access at least one of the following: at least one grouping, at least one information subgroup, at least one piece of information, at least one day or event view, at least one conversation view, a user defined view, and the like. In one embodiment, access point 239A-E is configured to allow a user to move from one user interface to another user interface or view, i.e., the access point acts as a trap door, passage, or link to at least one other user interface. As described further below, access points 239A-E may be configured to move a user from one user interface, e.g., the user interface illustrated in FIGS. 2B-2G, to another user interface, e.g., the user interface illustrated in FIGS. 5A-5B. In another embodiment, at least one access point 239A-E may be represented by another type of alphanumeric and/or graphic as discussed herein. For example, a user may click or touch access point 239D to move from a user interface that illustrates a group 236D to a subgroup or an individual information user interface displaying additional, more detailed, complementary, or supplemental content, e.g., the user interface described herein and illustrated in FIG. 2F. In another example, a user may click an access point to move from an information group user interface containing all of the days in the last year into a subgroup called a ‘day view’ showing all of the information within a single day, and then may further select another access point to move from the day view user interface into another view or user interface where a user can view at least one information element for example, to a specific photograph taken on that day, or into a conversation which was held during that day. For example, a day view may be a group of electronic photographs with a common time and location radius. These access points may also be used in the reverse order to move from at least one information element, to a subgroup, and further to a group user interface or any other combination of movements, e.g., move from more specific content to less specific content or move from less specific content to more specific content. In yet another example, an access point may be used to move from a day view or a conversation view to a subgroup or an individual information element or record. In another embodiment, at least one access point may be programmed to be included or combined in another element discussed herein, e.g., at least one access point may be combined with at least one information group 232 or at least one representative information sample 236A-E.

In the illustrated embodiment, five information groups 232A-E, representative information samples 236A-E, description and subtitles 238A-E, and access point 239A-E are visible on display 206. In another embodiment, fewer or a greater, but limited number of these information groups 232A-G may be displayed on the display 206. In the illustrated embodiment, a user may view information groups not currently displayed by contacting display 206 and moving down 208B to view information earlier in time and/or moving up 208A to view information later in time.

FIG. 2B also illustrates share/unshare buttons 246 and a delete button 248 where a user of interface 230 can share and/or unshare information 232 with other users and delete information from the information library or memory of the computer device 200. Although the description of these buttons is included here, the concept of these buttons may be included by one skilled in the art to other exemplary embodiments discussed herein. By sharing information, a user can provide access to one or more pieces of information, e.g., one or more electronic photographs, to one or more other users of an information sharing system. By unsharing information, a user can remove or limit access to one or more pieces of information previously shared with one or more other users of an information sharing system. By deleting information, a user can remove, cancel, or delete one or more pieces of information from their entire library, which may also remove, cancel, or delete the same from libraries of other users of the information sharing system. In another embodiment, more or less than the number of buttons displayed in FIG. 2B may be included in a user interface. In another embodiment, the layout of the buttons or functionality of the buttons may vary from what is illustrated in the exemplary embodiments. For example, the buttons may not be permanently displayed, rather the buttons may be at least partially hidden behind a smaller element (a button, an access point, and the like), or the menu that displays these buttons may be accessible via some input (action or gesture) on or with the interface. In yet another embodiment, a rating feedback system having collaborative filtering provides rankings may be included in the user interface. For example, a user may explicitly provide rankings by clicking 1, 2, 3, 4, or 5 stars or may implicitly provide rankings when information is shared with other users, the number of times something is shared, or the average length information is shared and the like.

In another embodiment, the user interfaces discussed herein may include a search box and functionality to long-press any piece of information (text or graphics) in the user interface to include an additional filter or index criteria that will further limit or focus in on the desired information. For example, a calendar date may be entered to display information in the user interface that includes metadata or content data that includes today's calendar date. In yet another embodiment, the user interfaces discussed herein may include a user interface or menu having functionality to create a bookmark, tag, and the like to make content available to others and/or to mark information that a user would like to easily locate at some future time, for example.

In another embodiment, the user interfaces discussed herein may include functionality that provides a user the ability to edit and comment upon content, e.g., edit and comment regarding photographs, data, medical records, and the like. For example, the edits may include functionality that allows users to edit content in an ongoing conversation, e.g., drawing onto content, drawing a funny mustache on a photo and making a comment or adding a thought bubble to the picture and adding a comment. Therefore, the image file becomes attached or connected with a comment, clicking on the comment would bring up a photo and one could apply the edit in the user interface. Further, dismissing or unselecting the photo would move the user interface back to the comment.

FIGS. 2C-2E illustrate exemplary views of computer device 200 having a third graphical user interface 250, according to an embodiment of the invention. At least the graphics module 122 renders and displays third user interface 250 having two concentric arc information banners 254A-B and titles 256A-H that are displayed over information 232, i.e., overlaid on information 232. In another embodiment, for example, information that includes data having an index of year, supplier, and part (index element 1, index element 2, etc.) may be represented in the user interface with three arcs, lines, circles, spheres, and the like.

In one embodiment, titles 256A-H may be substantially similar to the description and subtitles 238A-E described above. As discussed further below, user input or the computer device can vary the display of the banners, titles, and/or the underlying information. Third graphical user interface 250 may be activated by a menu selection, an application virtual button, a soft button, at least one predetermined movement on a touch-sensitive screen, a computer device input, a keyboard shortcut, and/or the like. For example, touching and holding a touch-sensitive visual interface and then moving or swiping to the right, left, up, or down may activate the third graphical user interface 250. In another embodiment, touching an application soft button or a virtual button on a display or touch screen may activate the third graphical user interface 250. In another embodiment, the third graphical user interface 250 may be activated by input from a keyboard, mouse, menu selection, program, voice command, and/or any activation method known by one skilled in the art.

As discussed herein, at least one of the modules renders and displays information 232, e.g., the graphics module 122 displays electronic pictures, and overlays third graphical user interface 250 on display 206. The transparency of the overlaid screen allows the user to orient with, and therefore view or glean information from, the underlying information 232 displayed on the display below. Furthermore, the overlay and the underlying information move in tandem, therefore, two levels or layers of information detail are provided and visible to the user. For example, the top overlaid user interface displays categories of information and the lower level displays specific or granular pieces of information, e.g., subgroups or elements of information.

In one embodiment, the third graphical user interface 250 overlays the information 232 and darkens the underlying information 232, as to highlight the user interface. In another embodiment, the third graphical user interface 250 overlays the information 232 with less or no darkening to the underlying content. In another embodiment, the portion of the display area (2-D) or volume (3-D) used to display information groups can be decreased to make room for the overlay. For example, the at least two overlays may be adjacent, but non-overlapping, both darkening the underlying content. In another embodiment, the at least two overlays or at least the overlay and the underlying information may be positioned adjacent to each other and not stacked or overlaid on each other.

In the illustrated embodiments of FIGS. 2C-2E, third graphical user interface 250 includes two concentric arc information banners 254A-B and at least one title 256A-H, each title 256 includes a description represented by letters and an optional subtitle or subtotal represented by a number in parentheses for each sorted/grouped information. In another embodiment, the user interface does not include the subtitle or subtotal represented by a number in parentheses for each sorted/grouped information. The two concentric arc information banners 254A-B are each a portion of two concentric circles. In another embodiment, the information banner(s) may be any partial or complete shape, including a partial or complete square, circle, and an oval when displayed in two-dimensions or a partial or complete cube, sphere, and the like when displayed in three-dimensions. For example, a larger portion of a circle, e.g., a smaller or larger arc or an entire circle, sphere, and the like may be illustrated on a larger display as a user zooms-out and a portion of the entire shape may be displayed in greater detail when the user zooms-in, depending on the size and characteristics of the display. In yet another embodiment, the shape may be a vertical or horizontal line, which thickens in width as a user zooms-out and thins in width as the user zooms-in. In another embodiment, the third graphical user interface may include banner(s) of a number less than or greater than two, depending on the resolution of the primary index or filter of the information. In yet another embodiment, the third graphical user interface may include titles that include alphanumeric text, graphics, images, and the like, or more or less information than shown in the illustrated embodiments. In another embodiment, the third graphical user interface may be configured to include a number of titles different than what is illustrated.

In another embodiment, the third graphical user interface is configured as a 3-dimensional display where moving in a third dimension provides two primary axes of information content. For example, in medical imaging, moving along a brain scan both in scale (from macroscopic to microscopic imaging) and along time (elapsed time), successive images or scans over the course of the elapsed time may show changes in tissue and the like (degradation of tissue and/or tumor growth). In another example, the third dimension may be represented on a 2-dimensional device using fading and perspective zoom in or zoom out functionality along the third dimension while still retaining the context discussed above. For example, the context in the third dimension would fade or otherwise diminish at a level that is inversely proportionate or correlated to the speed of movement through it.

Information banners 254A-B may also display a label 258 that indicates the index used to sort or group information 232. In another embodiment, the information banner label(s) include a preset description from the information metadata or indicate a user adjustable setting or description. For example, information 232 may be sorted or grouped by a date index, therefore banner 254A may indicate a year label 258 displaying at least one year in the entire information library that is visible in the third graphical user interface 250. Further, banner 254B has a month label 258 indicating the month or some other descriptive grouping or element of the information. In the illustrated embodiment, the information 252 displayed in banner 254B is a more detailed subset of the information represented by banner 254A.

At least the graphics module 122 of user interface module 120 renders and displays third user interface 250 having two concentric arc information banners 254A-B and titles 256A-H over information 232, i.e., overlaid on information 232. As discussed herein, computer device or user input can manipulate or change the display 206 of the third user interface, including the banners, title, labels, and/or the underlying information displayed. The information 232 displayed on the two concentric arc information banners 254A-B may represent the complete information library or a portion of the complete information library accessible by one or more users through third graphical user interface 250. For example, the complete information library may be a complete electronic photograph library. The complete information library may be stored and accessed locally, remotely, via a cloud based system, or any combination and any storage and access method known by one skilled in the art of electronic memory. For example, when a user is accessing an electronic photograph library on a computer device using third graphical user interface 250, the total number of pictures in an electronic photograph library or the total amount of information in a database are graphically represented based on the index or filter used to sort or group the information. The total number of pictures or information may be sorted in a reverse chronological order, counter clockwise along information banner 254A where each point identified by an indicator 260 on the information banner(s) 254 corresponds to a group of information. Further, each point identified by indicator 260 may be a specific piece or element of information depending on the total quantity of information stored in the library and the configuration of the information banner 254. In another embodiment, the indicator is optional or may have another shape, e.g., rectangle, square, circle, triangle, line, etc.

As briefly mentioned above, user input or the computer device may change the display of the banners, titles, and/or the underlying information in the third graphical user interface 250. In the illustrated embodiments of FIGS. 2C-2E, the level of detail displayed in third graphical user interface 250 is controlled by the location of the user's finger, or some other input device like a mouse pointer, relative to the two concentric arc information banners 254A-B. The vertical position of the user's finger relative to the information banners will move/rotate the information banner and therefore determines the portion of the information library that is displayed on third user interface 250. In another embodiment, the third graphical user interface 250 is controlled by an input relative to the center point of the concentric arcs 254 and the like. The physics module 124 assigns each element in the display physical properties, such as mass, position and current velocity. The physics module translates user input into accelerations which act on elements in the display according to the physical properties of each. Environmental forces, such as friction and gravity, act upon each element as well, ensuring that the movements initiated by the user input do not continue indefinitely.

In the illustrated embodiments, a user's finger providing input to touch-sensitive visual interface or display 206 is represented by a dashed circle 262 and the dashed line directional arrow 264 illustrates a direction of the user's finger movement on display 206. More specific information 232 and titles 256 and less of the information banner 254 (a change in the shape of the arc) are displayed in third graphical user interface 250 as the user's finger moves closer to the information banners 254A-B, zooms-in to the information banners. Moving left towards the arcs, as illustrated in FIGS. 2D-E, changes the shapes or portions of the arcs visible in the third graphical user interface 250, the arcs changing into vertical line shapes in FIG. 2E, and may change the underlying information 232 and titles 256, as illustrated by the change in tile pattern in FIG. 2D to FIG. 2E. Furthermore, the illustrated corresponding change in titles from titles 256J-Q in FIG. 2D to titles 256R-W in FIG. 2E. For example, the titles may change from Jul. 4, 2011—New York, Andrew to Mon., Jul. 4, 2011-Midtown West, New York City, N.Y., Andrew L., Sarah Q., and Dwight L as the user moves closer to the information banners searching for more specific information. In another example, the titles of The Decline and Fall of the Roman Empire may change from Chapter 27 A.D. 379-395: Gratian, Arianism. Ambrose, Theodosius, Valentinian to Chapter XXVII, 380 Ruin of Arianism, 383 Death of Gratian, 387 1st civil war: Maximus, 388 Theodosius, 390 St. Ambrose, 391 Valentinian, 392-394: 2nd civil war: Eugenius as the user moves closer to the information banners searching for more specific information in a book or the like. Further, more general information 232 and titles 256 and more of the information banner 254 are displayed in the interface 250 when the user's finger moves away from the information banner. Moving to the right away from the arcs as illustrated in FIG. 2C displays a more complete view of the information banners 254A-B and displays a more general range of titles 256A-H that include descriptions from A(1) to ZZ(7). For example, the titles may change in specificity from Jul. 4, 2011—Midtown West NYC to Jul. 11, 2011—New York as the user moves away from the information banners searching for more general information.

In FIGS. 2C-E, third graphical user interface 250 may be configured to allow a user to spin the information banners 254A-B about an axis (not shown) to quickly move to another location on the information banners 254A-B and to quickly view the underlying information 232 and/or information groups. At least the physics module 124 and the animation module 126 provide computer instructions for this feature. The information banners 254A-B spin and underlying information 232 passes through the visible display when a user's finger moves up or down on display 206 when third graphical user interface 250 is active. Any movement of the user's finger relative to the user interface results in a change and/or movement of the underlying information, scrolling the information to a point in the information that corresponds to a user's position on the third user interface. Once a user locates desired information, at least the graphics module 122 allows the user to select an information group 232 and select more specific or individual information via the user interface or another user interface.

The zoom level (state of zoom) in which the arc was last left while navigating between more or less specific information controls the visible scale of information along the primary dimension. This zoom level affects the speed at which the information banners 254A-B spin. Using the animation module 126 and/or the physics module 124 discussed herein, the rate of the spin motion can be made to comport satisfyingly with the actual physics of a virtually rotating platter containing thereon the information group content, e.g., text and graphics. Further, a user may initiate a shrinking action or an expanding action to change the size or zoom level of the display of the information groups and the underlying information 232.

In one embodiment, the user interface may be considered to be elastic because the user's finger can move in any direction (up, down, left, right, at an angle, sideways, etc.), resulting in a change and/or movement of the underlying information and titles or information groups, scrolling the information to a point in the information that corresponds to a user's position on the third user interface. In yet another embodiment, the user interface may be considered to be inelastic, rigid, fixed, or solid because the user's finger can move in an up and down direction, resulting only in a change and/or movement of the underlying information, essentially spinning the user interface. The organization of what information, e.g., photos, text, and/or data, and what information groups appear when a user moves their input (finger, stylus, mouse arrow, etc.) in any direction comes from a priorities algorithm. For example, information and information groups that come from locations further away from the user input location may appear more prominently in the user interface because the priorities algorithm may determine that a user may be more inclined to see this location to distinguish the content. In another embodiment, the priorities algorithm may emphasize information that a user has selected more frequently based on past behavior, or that other users have selected frequently or some other combination of criteria, e.g., volume of content, combination of users, etc.

In the illustrated embodiments, the third graphical user interface 250 is modal, allowing the interface 250 to remain active until a user locates desired content or until a user elects to exit the interface. A user can exit or deactivate the user interface similar to the ways discussed above to activate the user interface. For example, the user can exit the user interface by selecting an information group (e.g., clicking, pressing) or by pushing the interface in the direction of increasing specificity until the arc, line, etc. reaches the natural limit (e.g., the most specific level of information content), at which point it fades or recedes into a deactivated state. In another embodiment, the third graphical user interface is non-modal, requiring the user to maintain contact (input) with the display and/or interface, inactivating a user interface when input is not maintained.

In the illustrated embodiment of FIG. 2F, a fourth graphical user interface 270 includes two information banners 272A-B and at least one title 274A-H, each title 274 includes a description represented by letters and a subtitle or subtotal represented by a number in parentheses for each sorted/grouped information. The two information banners 272A-B are each a portion of two adjacent vertical banners that form a linear timeline with the most recent information positioned at the top of the banner and earlier information positioned towards the bottom of the banner. Further in the illustrated embodiment, fourth graphical user interface 270 may also include an overlay 276 generated by at least the graphics module 122 discussed herein. The graphics module 122 and the user interface module 120 determine when and where contact is made with the portion(s) of the fourth graphical user interface 270 that represents the overlay 276 and to further detect when user contact moves and/or when the user maintains contact with the overlay. Further, overlay 276 may be used to activate the user interface or the interface may be activated by a menu selection or the like.

In the illustrated embodiment, overlay 276 includes a transparent rectangular channel 278 (illustrated in dashed lines) extending between the top and bottom of the user interface and a solid line rectangle 280 on the left side of the user interface 230. The transparent rectangular channel 278 represents the entire information library, each information group represented at a location between the top and the bottom of the channel proportional along the vertical dimension of the screen to each information group's location in the entire information library. Information groups that correspond to a current location along the rectangular channel overlay 276, 278, and in accordance with the size of the display interface, are visibly represented in the display 206. The transparent rectangular channel 278 is an interface where the user can quickly select, e.g., fast scroll, to a specific location of the information library by touching any portion of the transparent rectangular channel 278, i.e., the interface jumps or quickly scrolls to a specific location. Furthermore, a user can scroll through the information library by touching any portion of the transparent rectangular channel 278 and then dragging up or down to scroll through the information library. Once a user arrives at a particular location of the information library, the user can stop providing input to the rectangular channel 278, therefore, inactivating fourth graphical user interface 270 and displaying information groups and the respective underlying information as displayed in FIG. 2B (for example). In another embodiment, a pull to the left or a movement to the left will activate the overlays described, for example, in FIGS. 2C-2E; that is, will activate the arcs 254.

In the illustrated embodiment, rectangle 280 on the left side is a visual indicator of a user's location in the transparent rectangular channel 278, i.e., the user's location in the entire information library, and also a perspective of where a user's finger or mouse arrow (some input) sits relative to the total batch of content or information. For example, if a user engages the rectangular channel 278 and the display illustrates relatively recent information or content, rectangle 280 will be illustrated at the top of the banners 272A-B, and if the display illustrates older information or content, rectangle 280 will be illustrated at the bottom of the banners 272A-B. In other words, the solid line rectangle 280 will move between the top and bottom of the user interface, following the user's contact made in transparent rectangular channel 278. For example, when a user touches top 280A of transparent rectangular channel 278, solid line rectangle 280 will move to the top left of the fourth graphical user interface 270 and the first information groups (based on the index) will be displayed on the fourth graphical user interface 270. Further, when a user touches bottom 280B of the transparent rectangular channel 278, solid line rectangle 280 on the left side will move to the bottom left of the second graphical user interface 270 and the last information groups (based on the index) will be displayed on the fourth graphical user interface 270. In another embodiment, the rectangular channel and rectangle may be on the same side or in a location different than illustrated, and one or both may be visible, transparent, or partially transparent, and/or may be another shape(s). In yet another embodiment, the rectangle that follows the user's contact with the rectangular channel may include a graphic or text, e.g., a date and/or time of the information or images displayed. In another embodiment, arbitrary pieces of text and/or graphical content may appear either along the left or right sides, in support of the content in rectangle 280, giving helpful context about what new information groups further movement along the primary information dimension will reveal. In another embodiment, the solid line rectangle or another shape indicates a user's location in the transparent rectangular channel, i.e., the user interface does not include information banners and the rectangle or the other shape has a date and/or time or another preprogrammed or user specified filter.

Illustrated in FIG. 2G are other exemplary embodiments where the information banner(s) are illustrated as another partial circle or a complete circle. For example, the displays 200 illustrated may be tablets or computer monitors, televisions, or the like. Therefore, a larger portion of a circle, e.g., a smaller or larger arc or an entire circle, sphere, and the like may be illustrated on the larger displays as a user zooms-out and a portion of the entire shape may be displayed in greater detail when the user zooms-in, depending on the size and characteristics of the display.

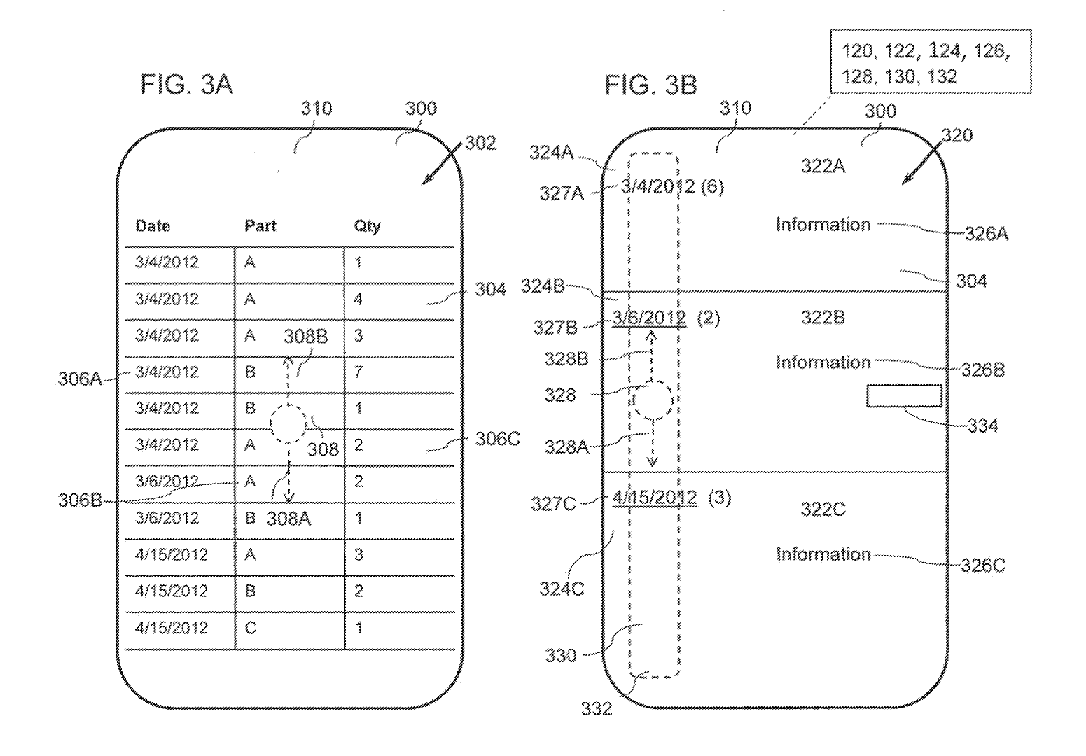

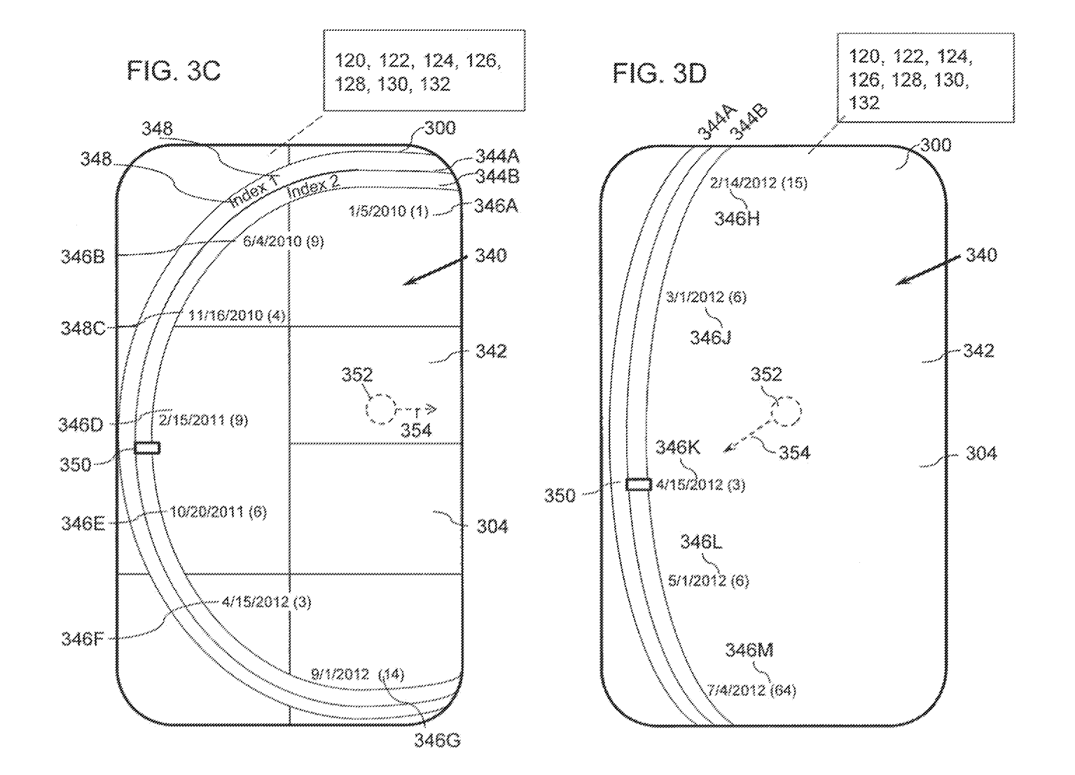

FIGS. 3A-D illustrate another exemplary computer device 300 displaying a first user interface 302 having information 304 in the form of electronic data 306A-C. Computer device 300 having user interfaces illustrated in FIGS. 3A-D are substantially similar to computer device 200 illustrated in FIGS. 2A-D as discussed above, except the information 304 is data 306, for example data in an electronic spreadsheet or a private or commercially available database and system. In FIG. 3A, electronic data 306A-C has an index that sorts the electronic data 306 by date and part. A user input 308 can move to other information 304 by moving up 308A and/or down 308B on touch sensitive display 310, as discussed above in reference to FIG. 2A.

FIG. 3B illustrates computer device 300 having a second graphical user interface 320, according to an embodiment of the invention. User interface 320 illustrated in FIG. 3B is substantially similar to computer device 200 and second graphical user interface 230 discussed above in reference to FIG. 2B. In the illustrated embodiment, graphics module 122 renders and displays information 304, e.g., electronic data, into information groups 322A-C (for example) in second graphical user interface 320 on touch-sensitive visual interface or display 310. The modules discussed herein use metadata (dates, date and part number, etc.) from information 304 to sort the information into one or more information groups 322A-C. At least one module discussed herein may be preset to sort information 322 into date range groups, grouping information 322 having a first data range into a first information group, e.g., information group 322A, and group information having a second data range into a second information group, e.g., information group 322B. A user may view information groups not displayed by contacting touch-sensitive visual interface 310 and moving down 328B and/or moving up 328A to view data information earlier in time or later in time, respectively. Substantially similar to aspects of FIG. 2B described above, second graphical user interface may include tiled portions 324A-C, at least one representative information sample 326A-C, and description and subtitles 327A-C

Further in the illustrated embodiment, second graphical user interface 320 may also include an overlay 330 generated by user interface module 120. The overlay 330 illustrated in FIG. 3B is substantially similar to overlay 270 illustrated in FIG. 2F and discussed above, except overlay 330 is a transparent rectangular channel 332 on the left side of the display, illustrated in dashed lines, extending between the top and bottom of the user interface, and the solid line rectangle 334 is on the right side of the user interface 320, indicating a user's position in transparent rectangular channel 332. As discussed above, the second graphical user interface 320 may operate as an independent graphical user interface as discussed above in relation to FIG. 2F or the second graphical user interface 320 may operate in conjunction with another interface as discussed above and as illustrated in FIG. 3B.

FIGS. 3C-3D illustrate multiple views of computer device 300 having a third graphical user interface 340, according to an embodiment of the invention. User interface 340 illustrated in FIGS. 3C-D is substantially similar to computer device 200 and third graphical user interface 250 discussed above in reference to FIGS. 2C-D, except the information is electronic data. For example, information 342, display labels 348, indicator 350, dashed circle 352, dashed line directional arrow 354, and banner titles 346H-M are substantially similar to like components described above in reference to FIGS. 3C-D. At least the graphics module 122 of user interface module 120 renders and displays third user interface 340 having two concentric arc information banners 344A-B and titles 346A-G over information 304, i.e., overlaid on information 304. As discussed above, computer device or user input can vary the display of the banners, titles, and/or the underlying information and the third graphical user interface 340 may be activated by a menu selection, an application virtual button, a soft button, at least one predetermined movement on a touch-sensitive screen, a computer device input, a keyboard shortcut, and the like.

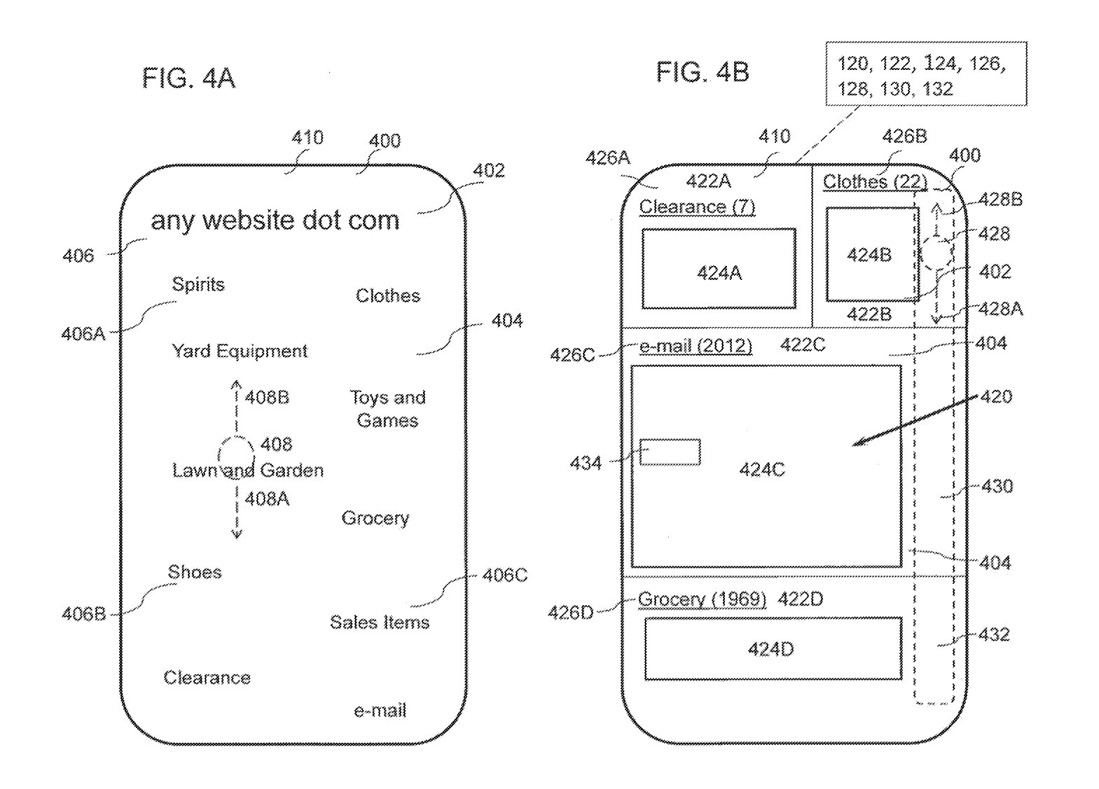

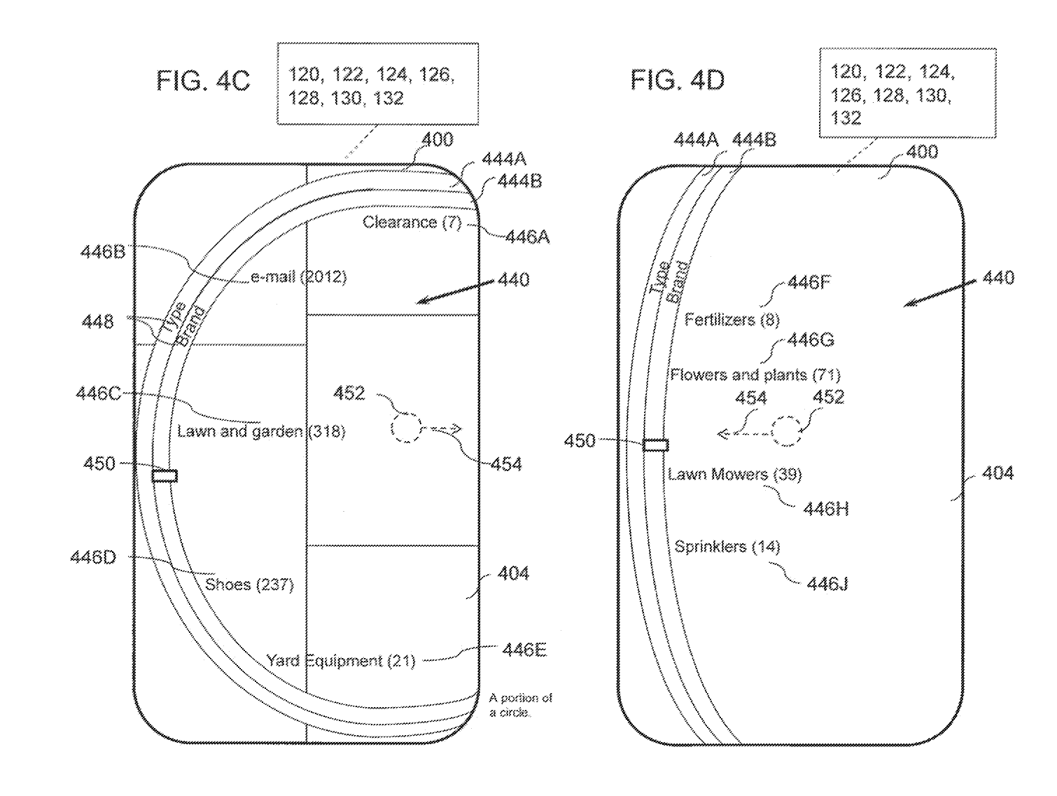

FIGS. 4A-D illustrate another exemplary computer device 400 displaying a first user interface 402 having information 404 in the form of text, graphics, sound, and video or website information 406A-C. Computer device 400 having user interfaces illustrated in FIGS. 4A-D are substantially similar to computer device 200 illustrated in FIGS. 2A-D as discussed above, except the information 404 is website information 406, for example website information from any website dot corn or the like. In FIG. 4A, website information 406A-C does not have an index that is visible to a user because the information may be randomly displayed on the website. In another embodiment, first user interface 402 may have an index that sorts/groups information 404 alphabetically. A user input 408 can move to other information 404 by moving up 408A and/or down 408B on touch sensitive display 410, as discussed above in reference to FIG. 2A, or by selecting a website link that may direct the user to another page within the website or to another website.

FIG. 4B illustrates computer device 400 having a second graphical user interface 420, according to an embodiment of the invention. User interface 420 illustrated in FIG. 4B is substantially similar to computer device 200 and second graphical user interface 230 discussed above in reference to FIG. 2B. In the illustrated embodiment, at least graphics module 122 renders and displays information 404 or website information 406A-C, e.g., electronic data, into information groups 422A-D (for example) in second graphical user interface 420 on touch-sensitive visual interface or display 410. As discussed above, at least one of the modules uses metadata or another type of website data (type, type and brand, date, date and part number, etc.) from information 404 to son the information into one or more information groups 422A-D. For example, a user may view information groups not displayed by contacting touch-sensitive visual interface 410 and moving down 428B or moving up 428A to view data information earlier in time or later in time, respectively.

Further in the illustrated embodiment, second graphical user interface 420 may also include an overlay 430 generated by overlay module 124. The overlay 430 illustrated in FIG. 4B is substantially similar to overlay 276 illustrated in FIG. 2F and discussed above, including having a transparent rectangular channel 432 on the right side of the display, illustrated in dashed lines, extending between the top and bottom of the user interface. Further, the solid line rectangle 434 is on the left side of the user interface 420, indicating a user's position in transparent rectangular channel 432.

FIGS. 4C-4D illustrate multiple views of computer device 400 having a third graphical user interface 440, according to an embodiment of the invention. User interface 440 illustrated in FIGS. 4C-D is substantially similar to computer device 200 and third graphical user interface 250 discussed above in reference to FIGS. 2C-D, except the information is website information. For example, display labels 448, indicator 450, dashed circle 452, dashed line directional arrow 454, and banner titles 446A-E are substantially similar to like components described above in reference to FIGS. 3C-D. At least user interface module 120 and graphics module 122 render and display third user interface 440 having two concentric arc information banners 444A-B and titles 446A-H. J over information 404, i.e., overlaid on information 404. In one embodiment, banner 444B may be a subset of banner 444A. As discussed herein, computer device or user input can vary the display of the banners, titles, and/or the underlying information and the third graphical user interface 440 may be activated by a menu selection, an application virtual button, a soft button, at least one predetermined movement on a touch-sensitive screen, a computer device input, a keyboard shortcut, and the like.

In the illustrated user interfaces discussed above, the user interface may be activated by a computer device input and/or may be activated by another user interface, e.g., a mouse or keyboard input, either local or remote activation. In another embodiment, more than one user interface may be activated at the same time. In yet another embodiment, the user interface(s) may morph from one mode to another. For example, changes in the user interface may include at least one of the following: the shape of the banner information (e.g., arc or flat timeline), modal or non-modal operating modes, filtering criteria (e.g., between distance from current location to time from current time), summary information (between time and location as primary information in titles), and primary information dimension (between time and scale). In another embodiment, changes in the user interface(s) may be initiated by arbitrary movement or activation of user interface elements. For example, movement to certain regions (past a left, right, top, or bottom threshold) or clicks to text or graphics may initiate user interface changes.

In another embodiment, the graphical user interfaces discussed herein may include an external indicator that dynamically links to additional relevant or closely related information. The external indicator may illustrate to the user that user interface includes access to an external source of information, e.g., a user populated encyclopedia and the like, related information groups such as pivots to filter criteria providing specificity or along alternative axes of information dimensionality. In another embodiment, viewing chronological photographs may include external indicators at any given point allowing a pivot directly into nearby locations or other events or occasions involving any subset of the current event's participants; the pivots would be from an undifferentiated timeline to one listing filtered information groups matching the terms of the pivot. If accompanying information includes text, the words and phrases themselves, and most especially, the concepts being discussed, provide useful pivots. In yet another embodiment, a user could target a specific point along one informational dimension by moving towards a point on the arc timeline until a threshold level of specificity is met, at which point the arc could reverse and associated banner information change to display the next informational dimension. This could continue serially for an arbitrary number of dimensions. In another embodiment, the user interface may include an external indicator at another location on the user interface or may include more than one external indicator.

FIG. 5A illustrates another exemplary computer device 500 displaying a first user interface 502A having two concentric arc information banners 504A-B that display information in the form of information groups 506A-H. As discussed herein, in another embodiment the information banners may be straight lines, a two dimensional shape, or a three dimensional shape. Computer device 500 having user interface 502A illustrated in FIG. 5A is substantially similar to computer device 200 and third user interface 250 illustrated in FIGS. 2C-D, except first user interface 502A sorts/groups information into information groups based on an index of a time stamp or a date of an individual's (or group of individuals') conversation about a piece of a specific electronic information or a group of several pieces of electronic information, e.g., the index may be a date index when the information was shared. In one embodiment, an information group is created, e.g., a conversation group is created, on a date when a first user shares an electronic photograph or other electronic information with at least a second user. For example, information group 506A may include the most recent conversation in user interface 502A entered by a first person regarding an electronic photograph(s) from the information library, such as a conversation surrounding an electronic photograph(s) from a birthday party. In one embodiment, the electronic photograph is shared in the background of the information group. Once the information group is created, other users of the system who have access rights may add additional comments or other content. Further, information group 506D may include a conversation at a later date/time by the same person or another person about any electronic photograph from the information library. In another embodiment, information group 506D may include a conversation and other content in reference to the same electronic photograph in group 506A, but information group 506D has an earlier date index based on when the information shared so it is illustrated lower on the user interface.

In the illustrated embodiment, first user interface 502A may include a first title 508A-H that includes for example at least a date or a name of the person (first, last, nickname, etc.) that started the conversation about the electronic information, e.g., a photograph, a medical record, or business data, and at least a first conversation 510A-H. As discussed above, the most recent started conversation would appear at the top of user interface 502A. In another embodiment, a filter may be applied to include conversations and/or electronic information that satisfies a user adjustable filter criteria, e.g., a user may enter a search or filter term(s). In the illustrated embodiment, a user may share or unshare access or may delete conversations based on system security configuration(s).

In the illustrated embodiment, the user interface allows users to share information, e.g., electronic photographs, in a common forum, see exactly who is included in the group, add comments, invite other users to view information and the related commentary, invite users to add to the forum, and/or add other information to the interface. Further, the time stamp index provides an approach to organize and share electronic photographs and information with other users and serves as an inbox and sorting mechanism.

Further in the illustrated embodiment, first user interface 502A includes at least one access point 512A-H in the form of a square that provides a gateway into another user interface. For example, at least one access point 512A-H may be used to access the information library or to toggle between the user interface illustrated in FIG. 5A and at least one of the user interfaces illustrated in FIG. 2B-2E and the like. In one embodiment, the at least one access point allows the user to access a conversation user interface, a summary view, at least one subset view of the summary view, a day view user interface, and/or a single image view in any order. As discussed above, the access points discussed herein act as a trap doors, passages, or links to and/or from another user interface. In another embodiment, at least one access point 512A-H may be represented by another type of alphanumeric and/or graphic as discussed herein.

As discussed above in reference to FIG. 2B, the user interfaces may include buttons that vary in layout or functionality. In the illustrated embodiment of FIG. 5A, the buttons illustrated towards the bottom of the interface provide access to an electronic photograph library, to an activity interface, to a camera interface, and to an interface that allows a user to change, modify, or update settings of an application, for example.

FIG. 5B illustrates another exemplary computer device 500 displaying a second user interface 502B having information groups 506A-H. Computer device 500 having second user interface 502B illustrated in FIG. 58B is substantially similar to computer device 500 and first user interface 502A illustrated in FIG. 5A, except second user interface 502B does not include information banners and second user interface 502B includes at least one access interface 512 that provides a gateway to another user interface. In another embodiment, the user interface may include at least one information banner.

In the illustrated embodiment, information groups 506A-H may include at least one electronic photograph or information as described herein. The information groups having at least one electronic photograph is sorted by an index, wherein the index may be a date, date and time, or date and location of the electronic photograph (for example). For information groups having access interfaces, 512B for example, the information groups may have a sorting index that may be the date and time the electronic photograph was added to the user interface. Therefore, an electronic photograph added to the user interface will be included in an information group having a date in the index based on the date it was added to the user interface, not the date of the electronic photograph, and the information group having recently added electronic photographs and/or conversation comments may be sorted so the newest additions are sorted at the top of the user interface, e.g., an electronic photograph and/or conversation inbox that is sorted from newest to oldest from top to bottom. At least one information group may include a title 508, a conversation 510, and an access interface 512. For example, information group 506B includes title 508B, conversation 510B, and access interface 512B and information group 506C includes title 508C, conversation 510C, and access interface 512C. Information groups 506A, 506D, and 506H include titles 508A, 508D, and 508H, respectively, however, they lack conversations and therefore lack access interfaces. In another embodiment, access interfaces may provide access to at least another user interface having a source of information as defined herein.

In the illustrated embodiment, titles 508A-H may include a location, a location and date, or may include other information as described in detail above. Further, the conversations 510B, 510C, and 510E may include a snippet or short portion of a conversation from at least one user that serves as a preview of more information in at least other user interface.

In the illustrated embodiment, access interfaces 512B, 512C, and 512E are represented by dashed-line rectangular boxes. Substantially similar to the access points described above, the access interfaces provide a gateway into another user interface that contains additional information and/or content. The access interfaces may include at least one information group. In the illustrated embodiment, access interface 512B includes information group 506B and access interface 512C includes information group 506C. Further, access interface 512E includes three information groups 508E, 508F, and 508G.

In another embodiment, at least one access interface may be used to access at least one of the following: at least one grouping, at least one information subgroup, at least one piece of information, at least one day view, at least one conversation view, a user defined view, and the like. For example, FIG. 5B may be described as a conversation view because the user interface includes at least one conversation 510B. In another embodiment, the user interface includes an access point that provides a user access to a conversation view (similar to FIG. 5A). In one embodiment, access interface 512 is configured to allow a user to move from one user interface to another user interface or view, i.e., the access point acts as a trap door or passage to at least one other user interface. Access interface 512 may be configured to allow access to a user from a user interface, e.g., the user interface illustrated in FIG. 5B, to another user interface, e.g., the user interface illustrated in FIG. 5A. In another embodiment, access interface may be configured to move a user from a user interface, e.g., the user interface illustrated in FIG. 5B, to another user interface, e.g., a conversation user interface where every information group includes at least one comment from at least one user or a conversation between two or more users. In another embodiment, at least one access interface may be represented by another type of alphanumeric and/or graphic as discussed herein. For example, a user may click or touch access interface 512B to move from a user interface that illustrates a group 506B to a subgroup or an individual information user interface. In another example, a user may click an access interface to move from an information group user interface into a subgroup called a day view, and then may further select another access interface to move from the day view user interface into another view or user interface where a user can view at least one information element. For example, a day view may be a group of electronic photographs with a common time and location radius. These access interfaces may also be used in the reverse order to move from at least one information element, to a subgroup, and further to a group user interface or any other combination of movements. In yet another example, an access interface may be used to move from a day view or a conversation view to a subgroup or an individual information element or record. In another embodiment, at least one access interface may be programmed to be included or combined in another element discussed herein, e.g., at least one access interface may be combined with at least one information group 232 or at least one representative information sample 236A-E.

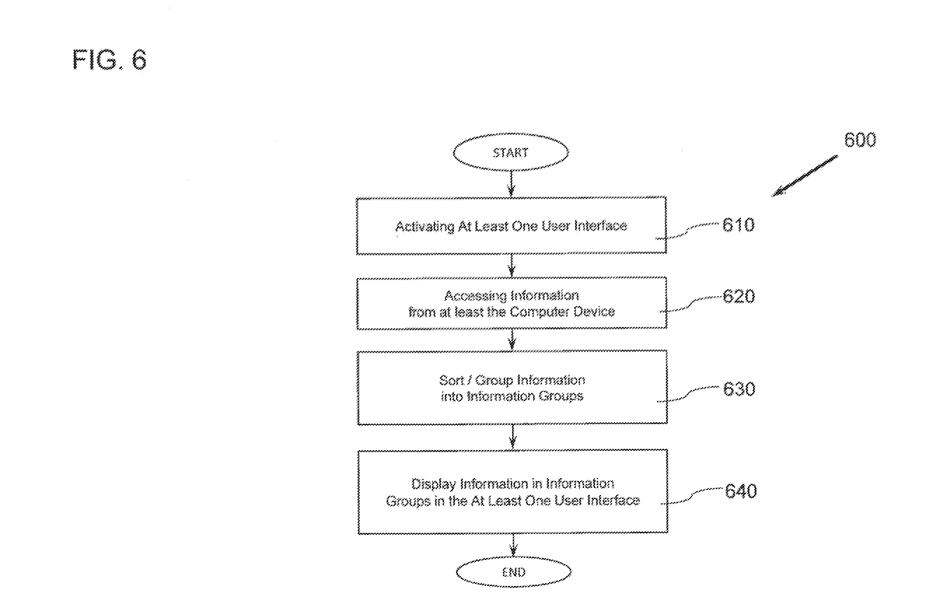

FIG. 6 illustrates a method 600 for displaying information on a display of a computer device using at least one user interface discussed herein. A user or a computer device activates at least one user interface at 610 and information, i.e., an information library, is accessed from at least the computer device at 620. When the at least one user interface is activated and the information is accessed, the information is sorted/grouped by an index (date and location for example) at 630 and information is displayed in the at least one user interface in information groups at 640. Optionally, information from another source (e.g., another user, another library, etc.) is included in the information and/or the sorted/grouped information groups, the user interface displays information groups and subsets or the like, the user interface receives scrolling input, the user interface receives at least one conversation regarding at least one piece of information, information is shared or unshared with other users, and/or the user interface receives input to review at least one information group.

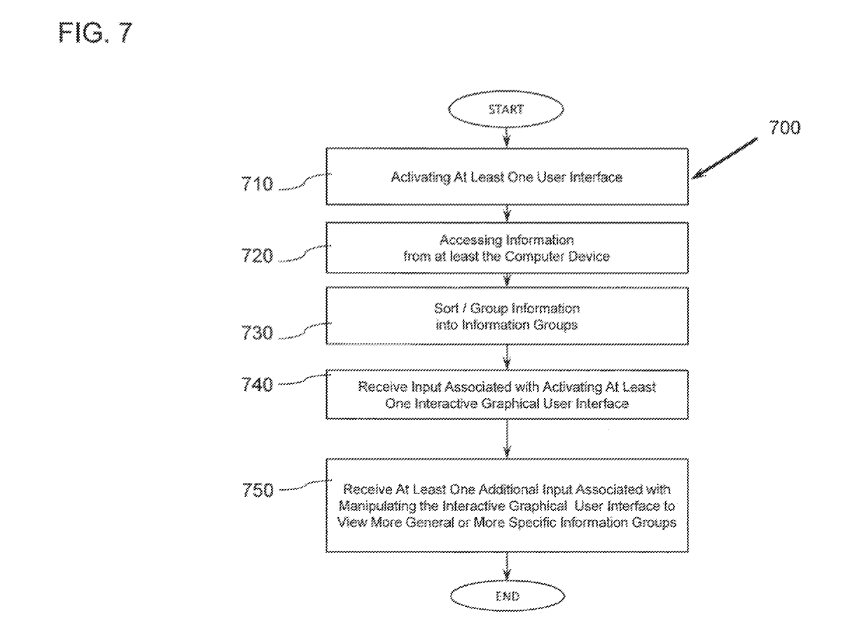

FIG. 7 illustrates another method 700 for displaying information on a display of a computer device using at least one user interface discussed herein. A user or a computer device activates at least one user interface at 710 and information is accessed from at least the computer device at 720. When the at least one user interface is activated and the information is accessed, the information is sorted/grouped by an index (date and location, date and user comment regarding at least one piece of information for example) into information groups at 730 and input is received that is associated with activating at least one interactive graphical user interface at 740. Optionally, at least one additional input is received that is associated with dynamically manipulating the interactive graphical user interface to view more general or more specific information groups at 750. Further, the method may optionally include information, conversation(s), and the like from at least one other user that is included, attached to, or linked to the information and/or the sorted/grouped information groups, the interactive graphical user interface displays information groups, subtitles, and subtotals or the like, the interactive graphical user interface receives scrolling input, information is shared or unshared with other users, and/or the user interface receives input to review at least one information group. In another embodiment, the method may optionally include manipulating the interactive graphical user interface by using at least one of the following inputs: pinching, reverse pinching, and dragging up and/or down on a touch-sensitive display to spin/rotate the interactive graphical user interface. In another embodiment of the methods discussed herein, at least one piece of information, e.g., an electronic photograph, is received and displayed in a user interface and at least one conversation or comment is included and determines the sort of the information from top to bottom of the user interface. In another embodiment of the methods discussed herein, at least one access point or access interface is included in a user interface that allows a user to move between at least two user interfaces discusses herein.

The embodiments of this invention shown in the drawing and described above are exemplary of numerous embodiments that may be made within the scope of the appended claims. It is understood that numerous other configurations of the graphical user interfaces may be created taking advantage of the disclosed approach. Description of information in terms of user interfaces and/or conversations is for convenience. It will be readily apparent to a person of ordinary skill in the art to organize, arrange, and display other iterations of the exemplary embodiments in a similar manner. In short, it is the applicant's intention that the scope of the patent issuing herefrom will be limited only by the scope of the appended-claims.

What is claimed is:

1. A computer implemented method, comprising:
at a computer device with a display:
in response to receiving input, accessing information from an information library;
sorting said information into information groups by grouping said information; and
displaying in a first graphical user interface on said display a single subset or multiple subsets of said information groups arranged adjacent to each other within the display, and wherein said information groups each include an access point.

2. The computer implemented method of claim 1, wherein said access point is a gateway into a second graphical user interface.

3. The computer implemented method of claim 1, wherein each of said information groups is displayed as a tile having a representative information sample when said information groups are displayed in said first graphical user interface.

4. The computer implemented method of claim 3, wherein said representative information sample is an item of information in said information groups.

5. The computer implemented method of claim 1, further comprising in response to receiving a further input, scrolling said information groups and displaying at least a portion of at least a second subset of said information groups in said first graphical user interface, and wherein said scrolling moves at least a portion of said single subset or multiple subsets of said information groups out of view in said first graphical user interface on said display.

6. The computer implemented method of claim 5, wherein said second subset is adjacent to said single subset or multiple subsets.

7. The computer implemented method of claim 5, wherein said information library has an entirety and said first graphical user interface further includes a channel having a first end and a second end, wherein said channel represents said entirety of said information library spanning between said first end and said second end.

8. The computer implemented method of claim 7, wherein said channel includes an indicator that indicates a location in said information library of said information groups displayed in said first graphical user interface.

9. The computer implemented method of claim 7, further comprising fast scrolling to a first position in said information library and displaying a corresponding information group on said display in response to receiving an input in said channel.

10. The computer implemented method of claim 1, wherein said information is grouped by using a first index including a date range and a location.

11. The computer implemented method of claim 1, wherein said graphical user interface is modal.

12. The computer implemented method of claim 1, wherein said information includes a photograph.

13. The computer implemented method of claim 1, wherein said information includes a plurality of information types, including a message, a conversation, or a comment.

14. The computer implemented method of claim 1, wherein said first graphical user interface includes a share input feature.

15. The computer implemented method of claim 1, wherein said first graphical user interface includes an external information indicator.

16. The computer implemented method of claim 2, wherein said second graphical user interface is a single information view.

17. The computer implemented method of claim 1, wherein said graphical user interface is configured to fade in.

18. The computer implemented method of claim 1, further comprising in response to receiving a further input, displaying an information banner overlaid on said information groups, wherein said information banner represents information from said information library, and wherein at least a portion of said information banner and at least a portion of underlying information groups move in tandem.

19. The computer implemented method of claim 18, further comprising displaying a second information banner adjacent to said information banner.

20. The computer implemented method of claim 18, wherein said information banner is a second graphical user interface.

21. The computer implemented method of claim 18, wherein said information banner further comprises categories of underlying information groups.

22. The computer implemented method of claim 18, wherein said adjacently arranged information groups are arranged vertically.

23. The computer implemented method of claim 18, wherein said information banner comprising a plurality of overlays.

24. The computer implemented method of claim 18, wherein said information banner rotates in response to an input.

25. The computer implemented method of claim 18, wherein said information banner and underlying information groups have unequal opacities.

26. The computer implemented method of claim 18, further comprising in response to receiving a further input, changing a zoom level of said information banner and underlying information groups.

27. The computer implemented method of claim 26, wherein a coordinate of said inputs controls said zoom level.

28. The computer implemented method of claim 26, wherein navigation of said inputs towards said information banner changes said zoom level to zoom-in to said information banner and underlying information groups.

29. The computer implemented method of claim 28, wherein said information banner further comprises categories of underlying information groups, and wherein said zoom level changes said categories to include more specific categories.

30. The computer implemented method of claim 26, wherein navigation of said inputs away from said information banner changes said zoom level to zoom-out from said information banner and underlying information groups.

31. The computer implemented method of claim 30, wherein said information banner further comprises categories of underlying information groups, and wherein said zoom level changes said categories to include more general categories.

32. The computer implemented method of claim 26, wherein said inputs are from a touch sensitive input device.

33. The computer implemented method of claim 26, wherein said information banner is at least a portion of an arc.

34. The computer implemented method of claim 26, wherein said information banner is at least a portion of a circle.

35. A computer-implemented method, comprising:
at a computer device with a display:
in response to receiving input, accessing information from an information library;
sorting said information into information groups by grouping said information; and
displaying in a first graphical user interface on said display an information banner overlaid on a single subset or multiple subsets of said information groups arranged adjacent to each other within the display, wherein said information groups each include at least one access point that is a gateway into a second graphical user interface, wherein said at least one information banner represents information from said information library, wherein at least a portion of said information banner and at least a portion of underlying information groups move in tandem in said first graphical user interface, and wherein said information banner displays categories of underlying said information groups; and
in response to receiving further input, changing a zoom level of said information banner.

36. A computer device comprising:
a display;
one or more processors;
memory; and
one or more programs, wherein the one or more programs are stored in the memory and configured to be executed by the one or more processors, the programs including:
instructions for accessing information from an information library;
instructions for sorting said information into information groups;
instructions for displaying in a first graphical user interface on said display an information banner overlaid on a single subset or multiple subsets of said information groups arranged adjacent to each other within the display, wherein said information groups each include at least one access point that provides a gateway into a second graphical user interface, wherein said information banner represents information from said information library, wherein at least a portion of said information banner and at least a portion of underlying information groups move in tandem in said first graphical user interface, and wherein said at least one information banner displays categories of underlying said information groups; and
instructions for changing a zoom level of said information banner.
